(19) United States
(12) Patent Application Publication
(10) Pub. No.: US 2009/0162708 A1
(43) Pub. Date: Jun. 25, 2009

(54) Regeneration of Sulfur-Poisoned Noble Metal Catalysts in the Fuel Processing System for a Fuel Cell

(76) Inventors: Tianli Zhu, New Haven, CT (US); Roger R. Lesieur, Enfield, CT (US)

Correspondence Address: Stephen A. Schneeberger, 49 Arlington Road, West Hartford, CT, 06107, US

(21) Appl. No.: 12/086,941

(22) PCT Filed: Dec. 23, 2005
(86) PCT No.: PCT/US05/47044

§ 371 Date: Jun. 20, 2008

(51) Int. Cl. H01M 8/06; H01M 8/04; B01J 7/00; C01B 3/32

(52) U.S. Cl. 429/17; 429/19

(57) ABSTRACT

A technique and equipment are provided for regenerating a potentially sulfur-burdened, noble metal catalyst (44) in a water gas shift reactor (150, 152, 154), which may be part of a fuel processing system (120) for a fuel cell power plant (110). An oxidant (91) is supplied to the reactor and catalyst during a period when the water gas shift reaction is terminated, and sulfur entities burdening the catalyst undergo an oxidation reaction to become SO₂. The SO₂ is then vented outside the system containing the reactor, as to the ambient. The oxidation reaction preferably occurs immediately upon the shift reaction being terminated to take advantage of the residual heat associated with the water gas shift reaction. Oxidant is conveniently admitted to the shift reactor and SO₂ is vented from the reactor by appropriately-controlled valving that may work in combined alternation with the normal flow of process fuel through the shift reactor and fuel processing system.

### TECHNICAL FIELD

This invention relates to fuel processing for fuel cells, and more particularly to the provision of a low-sulfur, hydrogen-rich fuel stream for a fuel cell. More particularly still, the invention relates to the regeneration of sulfur-poisoned, noble metal catalysts in a fuel processing system for a fuel cell power plant.

### BACKGROUND ART

Fuel cell power plants that utilize a fuel cell stack for producing electricity from a hydrocarbon fuel source are well known. The raw hydrocarbon fuel may be natural gas, gasoline, diesel fuel, naphtha, fuel oil, or the like. In order for the hydrocarbon fuel to be useful in the fuel cell stack's operation, it must first be converted to a hydrogen-rich fuel stream through use of a fuel processing system. Such hydrocarbon fuels are typically passed through a reforming process (reformer) to create a process fuel (reformate) having an increased hydrogen content that is introduced into the fuel cell stack. The resultant process fuel contains primarily water, hydrogen, carbon dioxide, and carbon monoxide. The process fuel has about 10% carbon monoxide (CO) upon exit from the reformer as reformate.

Anode electrodes, which form part of the fuel cell stack, can be burdened or “poisoned” by a high level of carbon monoxide. Thus, it is necessary to reduce the level of CO in the process fuel, prior to flowing the process fuel to the fuel cell stack. This is typically done by passing the process fuel through one or more water gas shift (WGS) converters, or shift reactors, and possibly additional reactors, such as one or more selective oxidizers, prior to flowing the process fuel to the fuel cell stack. The shift reactor also increases the yield of hydrogen in the process fuel stream.

However, the raw hydrocarbon fuel source and/or even the air supplied to certain types of reformers, may also contain sulfur compounds, and hydrogen generation in the presence of sulfur results in a poisoning effect on all of the catalysts used in the hydrogen generation system, as well as the fuel cell anode catalyst itself.

To mitigate this problem, at least with respect to the fuel as a source of sulfur, the hydrocarbon fuel source is typically passed through a desulfurizer, either prior to or following the reforming process, to remove in a known manner, as by converting sulfur from the gaseous form to a solid, substantial quantities of sulfur prior to the fuel entering the sulfur-sensitive components of the fuel processing system and fuel cell. Examples of such desulfurizers and descriptions of the associated process may be found in U.S. Pat. Nos. 5,769,909 and 6,159,256. Additionally, a U.S. Pat. No. 6,299,994 discloses the use of desulfurizers and other components of various fuel processing systems with the goal of providing a “pure” hydrogen stream for the fuel cell.

In a typical example, natural gas feedstock may have a sulfur content of 6 ppm-wt. fuel Though substantial sulfur is removed by the desulfurizer from the hydrocarbon fuel stream being processed, nevertheless sulfur levels of 25 ppb-500 ppb wt. fuel or greater, typically remain. Such diminished levels of sulfur in the fuel may be tolerated by the catalysts in the reformer, in part due to higher operating temperatures. The reformation process dilutes the fuel stream such that the reformate issuing from the reformer may typically have sulfur levels in the range of 5 ppb-100 ppb wt. reformate.

As also noted above, the ambient air supplied to certain types of reformers may also contain objectionable amounts of sulfur. This is particularly the case with autothermal reformers (ATRs), especially if they are located in regions of high sulfur content in the ambient air. Thus, depending upon what, if any, sulfur abatement measures are taken with respect to both the fuel and air paths in undergoing reformation, particularly with an ATR, there often remains a sulfur content in the reformate that is objectionably high.

While the large volume of catalyst used in earlier prior art in the remaining elements of the fuel processing system and the fuel cell itself may have tolerated such sulfur levels in the reformate, the more recent catalysts are more active and are used in much smaller quantities. They therefore tend to result in increased sensitivity to sulfur, even at the reduced sulfur levels in the reformate. The presence of sulfur in the reformate, even in reduced levels, accumulates on and ultimately “poisons” the noble metal catalysts downstream thereof, resulting in increasingly degraded performance. This “poisoning” may occur as the result of H₂S adsorbing on or forming sulfides with, the catalyst which then block active sites, and/or also through the agglomeration of the noble metal catalyst which also results in a decrease in activity. Moreover, the H₂S may cause sulfates and/or sulfides to form on the catalyst support material, some of which, such as ceria, may normally contribute to the water gas shift reaction to the extent not burdened by the presence of such sulfides and sulfates.

Thus, there has been a need to address the presence of even these reduced levels of sulfur where the catalysts of those components of the fuel processing system downstream of the reformer and desulfurizer are of the newer, more active type. One such technique appears in U.S. Patent Application Publication U S 2004/0035055 A1 by Zhu et al, and is described hereinafter with reference to Prior Art FIG. 1.

Referring to FIG. 1, there is depicted, in simplified functional schematic diagram form, a fuel cell stack assembly (CSA) 16 and fuel processing system (FPS) 20 of a fuel cell power plant 10 in accordance with the Prior Art. Briefly, a sulfur-containing hydrocarbon fuel feedstock, represented by supply line 22, is delivered by a pump or blower 24 to a desulfurizer 26 at the input, or upstream end, of FPS 20. The sulfur may be present in the form of hydrogen sulfide (H₂S), as well as mercaptans, sulfur oxides, etc. Following high-level desulfurization, the hydrocarbon fuel feedstock is admitted to a reformer 30 where, in the presence of steam, and possibly air, supplied on line 32, it is reformed in a well known manner to provide a hydrogen-rich reformate on line 34. The reformate, in addition to containing H₂ and CO, also contains any residual low level sulfur not removed by the desulfurizer 26, typically as H₂S. That sulfur may be present at the level of about 5 ppb-100 ppb wt. reformate, or greater. The result is substantially the same if the high-level desulfurization occurs immediately after the reformer 30, rather than before.

To reduce the level of CO in the reformate 34, the reformate undergoes a shift reaction in the water gas shift (WGS) section 50 to shift CO to CO₂ and to further enrich the H₂ in the process fuel stream. The WGS section 50 consists, in this embodiment, of a high temperature shift reactor 52 as a first stage, typically operating at 300°-450° C., and a low temperature shift reactor 54, typically operating at 200°-300° C., as a second stage. The traditional Fe/Cr oxide and/or Cu/ZnO shift catalyst used in earlier shift reactors has been replaced with a relatively active metal shift catalyst (not separately shown) in the high temperature shift reactor 52. A similar, though not necessarily the same, relatively active metal shift catalyst is present in the low temperature shift reactor 54.

That active metal shift catalyst consists of noble metal catalysts, such as platinum, and/or base metal catalysts having a relatively greater catalytic activity than the earlier Fe/Cr oxide and Cu/ZnO catalysts, and is advantageously supported by, or on, a metal oxide promoted support, such as ceria. This increased activity allows use of relatively smaller WGS reactors and/or less WGS catalyst.

Because of the susceptibility of the smaller quantities of the relatively active metal shift catalysts, as well any relatively active metal catalysts of the selective oxidizer 60 and fuel cell anode 18, to sulfur poisoning by even low levels of sulfur at their respective relatively low operating temperatures, the system of FIG. 1 provides a guard bed 70 to remove sufficient sulfur from the reformate/process fuel stream 34 to allow safe and effective processing/utilization of that stream downstream thereof. The selective oxidizer 60 typically operates at 100-150° C., and the temperatures in the CSA 16 are typically less than 100° C. That guard bed 70 is shown and described as being located immediately prior to (i.e., upstream of) the high temperature shift reactor 52, with mention that additional such guard beds could be included elsewhere in the fuel-processing stream if required. The guard bed 70 is represented as a chamber containing a “bed” of guard material 72, which may be in the form of tablets, or pellets, or may be wash-coated onto a monolith or a foam, or extruded, and is disposed in the bed chamber in a manner for fluid flow of the reformate 34 thereover and therethrough to facilitate sulfur adsorption.

Reformate 34 is supplied to the guard bed 70 via a multi-way inlet valve 74 and inlet conduit 75. Effluent processed by the guard material 72 exits the guard bed 70 via outlet conduit 76 and a further multi-way valve 78, and is supplied to the high temperature shift reactor 52 via conduit 34′ as processed reformate having any sulfur content reduced to an acceptable level, normally below about 20 ppb wt. reformate, and even below about 5 ppb-wt. reformate.

That guard material 72 in the guard bed 70 is said to be a material that can adsorb or remove sulfur and form stable sulfides, from levels of H₂S in the process fuel stream temporarily as high as 1 ppm-fuel wt., such as during upsets, or the more usual lower levels of between 100 ppb to 5 ppb wt. reformate downstream of the desulfurizer 26 and reformer 30 during normal operation. Moreover, that guard material 72 is said to be capable of durable and satisfactory operation at the temperatures and flow environment encountered at its selected location in the fuel-processing stream. The guard material is selected from the group consisting of ZnO, CuO, Cu/ZnO, Ce oxides, metal-doped Ce oxides typically of Ce/Zr or Ce/Pr, Mn oxide, Mg oxide, Mo oxide, Zr oxide, and Co oxide, either alone or in combination with a CeO₂-based support. ZnO, CuO on CeO₂-based support, and Cu/ZnO are said to be preferred, with ZnO being particularly preferred.

Ceria provided a support that acts chemically, cooperatively with CuO supported thereon, to enhance the adsorbant characteristics of the supported material. The ceria adsorbs sulfur itself. When ceria is reduced, it has oxygen vacancies that can be sulfur adsorbers. The principal mode of sulfur removal is said to be through the action of surface adsorption by the guard material 72, which serves to capture the sulfur in the passing H₂S and convert it to a sulfide of the guard material.

After extended usage of the guard bed 70 to remove sulfur, the effectiveness of the guard material 72 is degraded by the accumulation of sulfide at the surface. An oxidant, such as air, is admitted to the guard bed 70, either directly or preferably via an inlet 80 to the multi-way valve 74. This is typically done while the FPS 20 is otherwise inactive, as for instance during shutdown of a vehicle in which the power plant 110 may be located. The oxidant reacts with the sulfide formed at the surface (at least) of the guard material 72 to readily form sulfur dioxide, SO₂, which then may be discharged as a gas, either directly through the system or via a further discharge outlet 82 from the multi-way valve 78.

While the afore-described arrangement of using a sulfur guard bed may be beneficial in reducing the level of sulfur in the system to more acceptable levels, it none the less requires the additional cost, both in money and space, of at least one sulfur guard bed.

Thus, there is a need to provide in the fuel processing system for a fuel cell, a relatively simple and economic technique and arrangement for the effective abatement, minimization, or avoidance of the deleterious effects to sensitive catalysts potentially caused by the presence of sulfur in the reformate.

There is further need to protect noble metal catalysts, particularly those in water gas shift reactors and other components downstream thereof, from the cumulative adverse effects of potentially unacceptable levels of sulfur. This need also applies to the protection of such noble metal catalysts on ceria supports.

### DISCLOSURE OF INVENTION

The present invention addresses the problem of even low levels of sulfur in the reformate entering the water gas shift reactor(s), and other sensitive catalyst-containing components downstream thereof, in a relatively more remedial than preventative manner, though it is preventative with respect to significant degradation of catalyst performance. According to the present invention, there is provided a technique and equipment for regenerating a potentially sulfur-burdened, noble metal catalyst and/or catalyst support in a water gas shift reactor, and possibly other sensitive catalyst-containing components downstream thereof, such as a selective oxidizer and the fuel cell stack itself, to minimize continued degradation of the catalyst performance and restore prior performance levels.

It has been recognized that the addition of oxygen, typically in the form of air, to sulfur-burdened, noble metal catalysts in an appropriate thermal environment, will effect an oxidation reaction with the sulfur to create SO₂, a gas, which may then be removed from the system. Similarly, the addition of O₂ will also effect an oxidation reaction with sulfides formed on catalyst supports such as ceria and the like, to create easily removed SO₂.

In accordance with the invention, provision is made for the selective introduction of an oxidant, such as air, to at least the water gas shift reactor(s) for oxidizing the sulfur-burdened catalyst and/or support to form SO₂. The noble metal and/or support is/are thereby regenerated, and the SO₂ is removed from the immediate system, as by venting away from the fuel processing system and the fuel cell stack assembly. This/these oxidation reactions typically require an elevated temperature and are preferably conducted during an interval when reformate is not being reacted in the water gas shift reactor(s), so as to avoid release of SO₂ downstream in the system and/or the exhaust venting of H₂. Accordingly, the oxidant is introduced to the reactor(s) preferably at or soon after the shutting-down process in order to make use of the residual elevated temperatures in the reactor and catalyst bed. The resulting SO₂ is similarly vented at that time. Appropriate valves, and timed control of those valves, provide an effective means to accomplish this end.

In a preferred arrangement, valving is provided at or near both the inlet and outlet of at least the high temperature water gas shift reactor for interrupting the flow of reformate into the reactor, for introducing a supply of air as oxidant, for blocking the flow of O₂ and SO₂-containing gas to the downstream components, and for venting SO₂. The valving may be manual, but is preferably automatic in response to a control scheme that initiates the oxidation reaction and catalyst regeneration substantially coincident with shutdown of the fuel cell and the fuel processing system. The regeneration mode cycle is completed when an SO₂ monitor (not shown) no longer detects SO₂ in the exhaust, or after a predetermined time interval.

The foregoing features and advantages of the present invention will become more apparent in light of the following detailed description of exemplary embodiments thereof as illustrated in the accompanying drawings.

### BRIEF DESCRIPTION OF DRAWINGS

FIG. 1 is a simplified functional schematic diagram of a fuel cell power plant having a fuel cell stack assembly and a fuel processing system with sulfur control in accordance with the prior art; and

FIG. 2 is a simplified functional schematic diagram of a fuel cell power plant similar to FIG. 1, but showing a fuel processing system with an improved arrangement for addressing the problem of the adverse impact of sulfur on sensitive catalysts and/or supports.

### BEST MODE FOR CARRYING OUT THE INVENTION

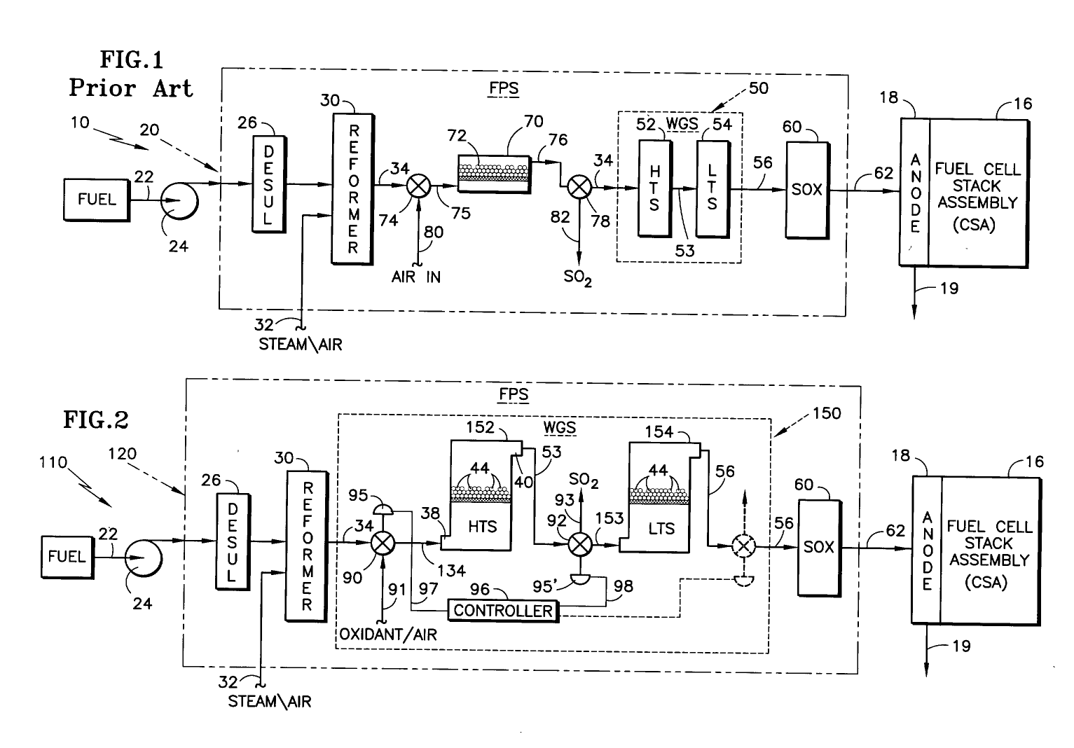

Realizing that a relatively thorough description of a representative fuel cell power plant was undertaken with respect to the description of FIG. 1 prior art, the following description of the invention with reference to FIG. 2 will “piggy-back” on that description of FIG. 1. Referring to FIG. 2, the elements that are essentially the same as their counterparts in FIG. 1 are given the same reference numeral as in FIG. 1, whereas those elements that are functionally similar but include some change in accordance with the invention, are similarly numbered but with a “1” prefix. Added elements are given new numbers. In FIG. 2, there is illustrated a fuel cell power plant 110 similar to that depicted in FIG. 1 with respect to the prior art, but differing principally in that it includes a fuel processing system (FPS) 120 with an improved arrangement for addressing the potential adverse impact of sulfur on sensitive catalysts and/or catalyst supports in accordance with the invention. The CSA 16 is typically of the proton exchange membrane (PEM) type, operating at temperatures less than 100° C. and pressures less than 1 atmosphere gauge, for example at 5 psig. It will be understood that the power plant 110 includes various elements and sub-systems that are well understood and a part of the normal functioning of the system, but which are not described herein because they are not essential to an understanding of the invention and its benefit to the system.

As noted previously, a sulfur-containing hydrocarbon fuel feedstock, represented by supply line 22, is delivered by a pump or blower 24 to a desulfurizer 26 at the input, or upstream end, of FPS 120. The hydrocarbon feedstock 22 may typically be natural gas, gasoline, propane, diesel fuel, naphtha, fuel oil, or the like, and is likely to contain various forms of sulfur at levels sufficient to pose a poisoning potential for the various noble metal catalysts in the system. Moreover, the term “hydrocarbons”, as used herein, should be viewed as including not only the heavier C—H-only hydrocarbons, but also the alcohols and other oxygen-containing hydrocarbons, at least to the extent they contain the presence of objectionable levels of sulfur. The hydrocarbon fuel feedstock is delivered to the FPS 120, and specifically a desulfurizer 26, by means of a pump, blower, or the like. The desulfurizer 26 is generally capable of reducing sulfur levels in the hydrocarbon feedstock 22 to levels of about 25 ppb-500 ppb wt. fuel, following which the feedstock is supplied to a reformer 30, for conversion or reformation at high temperature, e.g., 600°-800° C., through the addition of steam (and possibly air) 32, to form a hydrogen-rich reformate that also includes significant CO. That reformate is provided on output line 34 from the reformer 30, and continues to contain residual sulfur at or below the levels provided by the desulfurizer 26, typically diluted by the reformation process, such that sulfur levels of 5 ppb-100 ppb wt. reformate remain. It should be understood that the relative locations of the desulfurizer 26 and the reformer 30 may be reversed, with a similar result occurring, because of the reformer's higher operating temperature-tolerance of sulfur and/or if possibly lower levels of sulfur are present in the hydrocarbon fuel feedstock.

To reduce the level of CO in the reformate 34, the reformate undergoes a shift reaction in the water gas shift (WGS) section 150 to shift CO to CO₂ and to further enrich the H₂ in the process fuel stream. The WGS section 150 consists, in this embodiment, of a high temperature shift reactor 152 as a first stage, typically operating at 300°-450° C., and a low temperature shift reactor 154, typically operating at 200°-300° C., as a second stage. Importantly, the shift catalyst used in the high temperature shift reactor 152 is a relatively active, supported noble metal shift catalyst 44. A similar, though not necessarily the same, relatively active supported noble metal shift catalyst is present in the low temperature shift reactor 154.

The relatively-active metal shift catalysts 44 are chosen from the group consisting of the noble metals rhenium, platinum, palladium, rhodium, ruthenium, osmium, iridium, silver, and gold. Preferred amongst the noble metal catalysts are platinum, palladium, rhodium and/or gold, alone or in combination, with platinum being particularly preferred because of a desirable level of activity per volume. The relatively active metal shift catalysts may be advantageously supported by, or on, a metal oxide promoted support, in which the metal oxide may be an oxide of cerium (ceria), zirconium (zirconia), titanium (titania), yttrium (yttria), vanadium (vanadia), lanthanum (lanthania), and neodymium (neodymia), with ceria and/or zirconia being generally preferred. The shift catalysts 44 may take the form of coated beads or pellets and be arranged in a reactor bed (as depicted), or they may constitute a coating on a foam or honeycomb-type structure, or various other forms known for use in shift reactors.

The introduction to the shift reactors 150, and particularly the high temperature shift reactor 152, of even the low levels of sulfur (as H₂S) in the reformate discussed above, will, over time, result in the “burdening” or “poisoning” of the catalyst(s) 44, including perhaps also their supports. This process typically results from the formation of metal sulfides or adsorbed sulfur species on the noble metal catalyst, as well as causing possible agglomeration of the catalyst. Moreover, sulfides or sulfates of cerium may form on ceria-based, catalyst supports, thus further depriving the catalyst bed of active sites. Under water gas shift conditions, Ce₂O₂S may be the dominant cerium sulfate species, according to the following previously-known reactions:

CeO₂+xH₂=CeO₂₋ₓ+xH₂O (1)

where “x” is the amount of H₂ that reacts with the CeO₂ to form H₂O. A corresponding amount of O₂ is consumed from the CeO₂.

2CeO₂₋ₓ+H₂S+(1−2x)H₂=Ce₂O₂S+2(1−x)H₂O (2)

The invention provides for the introduction of an oxidant, such as air, to the water gas shift register(s) 150, and particularly to the high temperature shift reactor 152, as depicted herein, for oxidizing the solid sulfur compounds formed on the catalyst 44, including the supports, to convert the solid sulfur compounds and adsorbed sulfur species to gaseous SO₂ for venting from the system. The removal of sulfur in this fashion has the effect of regenerating the catalyst and/or its support nominally to its original state. As an example with respect to the metal oxide promoted support, ceria (CeO₂) in a preferred example, the oxidation process/reaction is as follows:

Ce₂O₂S+2O₂=2CeO₂+SO₂ (3)

The oxidation reaction is preferably conducted at temperatures that exceed 150° C., as for instance at temperatures approaching those to which the supported catalyst(s) 44 are exposed during normal water gas shift reactions. Because of this thermal requirement and because this oxidation reaction is conducted other than while the water gas shift reaction is occurring, it is preferable that the oxidation reaction be initiated when the shift reactor is hot, either during a warm-up or, preferably, immediately upon terminating the water gas shift reaction upon a shut down. It is also possible, though less efficient, to apply supplemental heat if the oxidation reaction is to occur some interval after shutdown and before start-up.

In a preferred embodiment as depicted in FIG. 2, the reformate/process fuel stream on conduit line 34 is connected to and through a first inlet of a first multi-way valve 90 and through conduit line 134 to an inlet or entry region 38 of the high temperature shift reactor 152 to one side or end of the bed of catalyst 44. A conduit 53 for the effluent stream from the high temperature shift reactor 152 extends from an outlet or exhaust region 40 of the reactor at the other, or opposite, side or end of the bed of catalyst 44. The conduit 53 extends to a second multi-way valve 92, which has a first outlet with a conduit 153 extending to the low temperature shift reactor 154 for delivery of the H₂-enriched, CO-shifted reformate to that reactor for further water gas shift reaction. The effluent from the low temperature shift reactor 154 is conveyed via conduit 56 to, and through, the optional selective oxidizer 60 and thence via conduit 62 to the anode 18 of the fuel cell stack assembly 16 as previously described.

In accordance with the invention, a source of oxidant, such as air, is supplied via conduit 91 to a second inlet of the multi-way valve 90. The valve 90 may be selectively controlled manually or automatically, as represented by the actuator 95, to pass either the reformate on line 34 or the oxidant on line 91 on a mutually exclusive basis to the conduit 134 connected to the inlet of shift reactor 152. Similarly, the multi-way valve 92 at or beyond the outlet 40 of the high temperature shift reactor 152 has a second outlet connected with a conduit 93 for venting or exhausting SO₂ formed during oxidation in the reactor. That valve 92 may also be selectively controlled manually or automatically, as represented by the actuator 95′, to pass the effluent in conduit 53 from shift reactor 152 on a mutually exclusive basis either onward via conduit 153 to the low temperature shift reactor 154 if it is the H₂-enriched, CO-shifted reformate from the normal water gas shift reaction in the shift reactor 152 or out of the system via vent line 93 if it is SO₂ resulting from the oxidation reaction.

The multi-way valves 90 and 92 are preferably controlled automatically and substantially in unison by a suitable controller 96 via control links represented as 97 and 98 respectively. It will be appreciated that the controller 96 may be part of the controls normally associated with a fuel cell power plant, and particularly the FPS portion 120 thereof. The control links 97 and 98 may be hard wired or wireless. The multi-way valve 92 between shift reactors 152 and 154 might instead be between shift reactor 154 and SOX 60, as shown in broken line form, if the oxidation reaction is to occur in both shift reactors 152 and 154.

Referring now to the operation, the multi-way valve 90 is normally set to allow the inlet conduit 134 for the high temperature shift reactor 152 to receive reformate from reformer 30 via conduit 34 to supply the water gas shift reaction in reactor 152, and the multi-way valve 92 is similarly set to allow normal flow from reactor 152 to reactor 154 and beyond via conduits 53 and 153 to power the fuel cell stack assembly 16. However, from time to time the water gas shift reaction is terminated and the oxidation reaction is initiated to remove accumulated sulfur from the reactor. This most conveniently occurs at the time of normally-occurring shutdowns. In the event the fuel cell power plant is aboard a vehicle, regeneration could occur when the vehicle is shut down and the power plant is still hot. At such time, the controller 96 commands the multi-way valves 90 and 92 to close their normal flow paths and switch to alternate flow paths for the oxidation reaction. The oxidant supply on conduit 91 becomes connected to the high temperature shift reactor 152 via valve 90 and conduit 134. Similarly, the exhaust flow path 53 from the reactor 152 becomes connected through valve 92 to the vent conduit 93 for discharging SO₂ from the system. This assures that the SO₂ is not passed to sensitive components downstream of this position. The catalyst regeneration is completed when an SO₂ monitor (not shown) no longer detects SO₂ in the exhaust, or after a predetermined time interval.

Alternatively, it is possible and may in some instances be preferable, to conduct the oxidation reaction shortly before the shift reactor resumes a new shift reaction cycle. For instance, when the shift reactor 152 becomes sufficiently warm in a pre-start, or start-up, mode, as from a supplemental heat source such as electrical or steam heat, the oxidant may be introduced to the shift reactor for the oxidation reaction, though without the presence of the fuel and/or steam flow otherwise required for the water gas shift reaction.

Although the invention has been described and illustrated with respect to the exemplary embodiments thereof, it should be understood by those skilled in the art that the foregoing and various other changes, omissions and additions may be made without departing from the spirit and scope of the invention. For example, although the described embodiment provided for the O₂ to enter the shift reactor from the same side, or end, of the catalyst bed as the reformate normally enters, the invention is also applicable to the oxidation occurring as a result of O₂ entering the reactor from the opposite side, or end, of the catalyst bed. Still further, while the above description was in the context of oxidation of a single stage of a 2-stage shift reactor, it will be understood that it is similarly applicable to oxidation of both stages, or of a single stage shift reactor, and may also embrace, with the shift reactor, additional catalyst-containing components down stream thereof. Even further, although the described preferred embodiment utilized a single, multi-way valve to alternately conduct reformate or oxidant to the shift reactor via a single inlet to the reactor, it will be appreciated that the process of the invention might similarly be practiced with separate valves and possibly separate inlets to the shift reactor. Similar provision may be made at the shift reactor outlet.

1. In a fuel cell power plant (110) having a fuel cell stack assembly (CSA) (16), including an anode (18), and a fuel processing system (FPS) (120) for converting a hydrocarbon feedstock fuel (22) to a hydrogen-rich fuel stream (34, 134, 53, 62) for the anode (18) of the CSA (16), the FPS (120) including at least a shift reactor (150, 152, 154) having a noble metal shift catalyst (44) for facilitating a shift reaction, the improvement comprising:
catalyst regenerating equipment (90, 91, 134, 92, 93, 153) with a fluid couple (91, 90, 134) between an oxidant source (91) and said shift reactor for selectively feeding an oxidant gas into said shift reactor to oxidize and convert sulfur associated with the noble metal shift catalyst to SO₂; and
said shift reactor being configured to discharge SO₂ in the absence of the shift reaction.

2. The fuel cell power plant (110) of claim 1 wherein the noble metal shift catalyst of the shift reactor is at a temperature of at least 150° C.

3. The fuel cell power plant (110) of claim 1 wherein shift reactor is configured to vent the SO₂ to the ambient in the absence of the shift reaction.

4. The fuel cell power plant (110) of claim 1 wherein said shift reactor has a normal flow inlet (38) and a normal flow exit (40), and the flow of said oxidant is from the normal flow inlet (38) to the normal flow exit (40).

5. In a fuel cell power plant (110) having a fuel cell stack assembly (CSA) (16), including an anode (18), and a fuel processing system (FPS) (120) for converting a hydrocarbon feedstock fuel (22) first to a reformate stream (34) and then to a hydrogen-rich fuel stream (34, 134, 53, 62) for the anode (18) of the CSA (16), the FPS (120) including at least a shift reactor (150, 152, 154) having a noble metal shift catalyst (44) located there within for facilitating a shift reaction, the improvement comprising:
means (90, 96) for terminating the shift reaction;
catalyst regenerating means (90, 91, 134, 92, 93, 153) connected to an oxidant source (91) and to the shift reactor at opposite ends (38, 40) with respect to the noble metal shift catalyst (44) for selectively admitting an oxidant to the shift reactor at one end (38, 40) to convert sulfur associated with the supported noble metal shift catalyst to SO₂ and discharging SO₂ from the shift reactor at the other end (40, 38); and
control means (95, 96, 97, 98) operatively connected to the catalyst regenerating means for admitting the oxidant to and discharging the SO₂ from the shift reactor substantially only while the shift reaction is terminated.

6. The fuel cell power plant (110) of claim 5 wherein the catalyst regenerating means comprise first valve means (90) operatively connected to an oxidant source 91 and to an end (38, 40) of the shift reactor for selectively allowing and terminating a flow of oxidant to the noble metal shift catalyst, and second valve means (92) operatively connected to an exhaust vent (93) and to an opposite end (40, 38) of the shift reactor for selectively allowing and terminating a discharge flow of the SO₂ from the shift reactor.

7. The fuel cell power plant (110) of claim 6 wherein said reformate stream (34) is also operatively connected to said first valve means (90), said first valve means being operable between first and second positions to alternately pass one of said oxidant and said feedstock fuel and block passage of the other; and said control means (96) being operatively connected to said first valve means for selective actuation thereof between said first and second positions.

8. For a sulfur-burdened, noble metal shift catalyst facilitating a water gas shift reaction of reformate (34) flowed into a shift reactor, the method of regenerating the noble metal shift catalyst comprising the steps of:
terminating the water gas shift reaction;
supplying an oxidant to the shift reactor and oxidizing the sulfur burdening the shift catalyst to create SO₂; and
venting the SO₂ from the shift reactor.

9. The method of claim 8 wherein the combined step of supplying an oxidant to the shift reactor and oxidizing the sulfur burdening the shift catalyst includes the step of applying or maintaining sufficient heat on the shift catalyst to support an oxidation reaction with the sulfur.

10. The method of claim 9 wherein the water gas shift reaction of said shift reactor operates at a temperature sufficient to support said oxidation reaction with sulfur, and wherein said step of oxidizing the sulfur comprises supplying the oxidant to the shift reactor in relatively close time proximity with said step of terminating the water gas shift reaction.

11. The method of claim 9 wherein the water gas shift reaction of said shift reactor operates at a temperature sufficient to support said oxidation reaction with sulfur, and wherein said step of oxidizing the sulfur comprises supplying the oxidant to the shift reactor during a period shortly before start-up of the water gas shift reaction.

12. The method of claim 8 wherein the step of terminating the water gas shift reaction comprises interrupting the flow of the reformate (34) to the shift reactor.

13. The method of claim 8 wherein the step of venting SO₂ from the shift reactor comprises directing the SO₂ away from the fuel processing system (120) and the fuel cell anode (18).
